(19) United States
(12) Patent Application Publication
(10) Pub. No.: US 2005/0208232 A1
(43) Pub. Date: Sep. 22, 2005

(54) Weather strip and method of manufacturing the same

(76) Inventors: Nobuyuki Kimura, Nishikasugai-gun (JP); Yoshihiro Kurosaki, Nishikasugai-gun (JP); Hiroshi Kuzuya, Nishikasugai-gun (JP); Yoshihisa Kubo, Nishikasugai-gun (JP)

Correspondence Address: POSZ LAW GROUP, PLC, 12040 SOUTH LAKES DRIVE, SUITE 101, RESTON, VA, 20191, US

(21) Appl. No.: 11/081,838

(22) Filed: Mar. 17, 2005

(30) Foreign Application Priority Data
Mar. 19, 2004 (JP) 2004-079697

(51) Int. Cl. B60R 13/00

(52) U.S. Cl. 428/31; 264/250; 264/259

(57) ABSTRACT

A weather strip includes an extruded portion and a molded portion. The molded portion is formed integrally with the end of the extruded portion. A method of manufacturing the weather strip includes removing at least one part of the end of a tubular seal portion of the extruded portion to form a thin wall portion, setting the end of the extruded portion and a core in a mold apparatus, and closing a movable mold of the mold apparatus in order to define a cavity. The cavity includes space corresponding to the removed part of the extruded portion. Further, the method includes filling a rubber-like material into the cavity to form the molded portion.

### CROSS REFERENCE TO RELATED APPLICATION

The present application is based on and incorporates by reference Japanese Patent Application No. 2004-079697, which was filed on Mar. 19, 2004.

### BACKGROUND OF THE INVENTION

The present invention relates generally to a weather strip having an extruded portion and a molded portion and to a method of manufacturing the weather strip.

Generally, a weather strip that is fixed on a peripheral portion of a door opening of a vehicle has a fixing base and a tubular seal portion. The tubular seal portion is formed integrally with the fixing base.

In manufacturing the weather strip, the extruded portion, which has an elongated body, is formed by a well-known extrusion molding process. An end of the extruded portion is formed to be cut along a plane that is perpendicular to the longitudinal direction of the extruded portion. As shown in FIG. 7A, a core 50, which is one part of a mold apparatus, is primarily inserted into the tubular seal portion from the end of the extruded portion 49 to a predetermined position for forming the molded portion. Next, the mold apparatus is opened and the extruded portion 49 and the core 50 are set at a predetermined position in the mold apparatus. Then, the core 50 and the extruded portion 49 are clamped by closing the mold apparatus. FIG. 7A shows a movable mold 51 that forms part of the mold apparatus. Thus, a cavity 52 for forming the molded portion is defined by various parts including the movable mold 51 and the core 50. Unvulcanized rubber is injected into the cavity 52. Then, the unvulcanized rubber is vulcanized in the mold apparatus by heating. Therefore, a molded portion 53 is formed. At the same time, the extruded portion 49 is connected to the molded portion 53.

An end of the extruded portion 49 is compressed in the closed mold apparatus. Therefore, when the weather strip is picked up from the mold apparatus after the injection molding process, as shown in FIG. 7B, the edge of the extruded portion 49, which had been compressed by the mold apparatus, expands outwardly due to its recovery from the compression. As a result, there may be a difference in dimension between the extruded portion 49 and the molded portion 53.

When the difference in dimension is great, the appearance of the weather strip is negatively affected. The seal performance is also reduced.

### SUMMARY OF THE INVENTION

The present invention overcomes the above-mentioned limitations by reducing the difference in dimension at the connecting portion between the extruded portion and the molded portion. Thus the present invention provides a weather strip and a method of manufacturing the same that improve the appearance and the seal performance.

The present invention provides a method of manufacturing a weather strip. The weather strip includes an extruded portion, a molded portion formed integrally with the end of the extruded portion. And the molded portion and the extruded portion have a tubular seal portion respectively. The method includes the steps of removing at least one part of the end of the tubular seal portion of the extruded portion in order to form a thin wall portion, inserting a core into the end of the seal portion of the extruded portion, closing a movable mold in order to define a cavity including the part corresponding to the removed part of the extruded portion after setting the end of the extruded portion with the core in a mold apparatus, and injecting a rubber-like material into the cavity in order to form the molded portion.

According to the above-mentioned method, the cavity defined by closing the movable mold includes a space that corresponds to the removed part of the tubular seal portion. Thus the thin wall portion is not compressed easily by the mold apparatus because of its thickness. Therefore, after the molded portion is formed, expansion around the end of the thin wall portion is restrained. As a result, a difference of the dimension between the extruded portion and the molded portion is limited at the thin wall portion. Therefore, the appearance and the seal performance of the weather strip are improved.

The present invention also includes a weather strip having an extruded portion, a molded portion formed continuously at the end of the extruded portion. And the molded portion and the extruded portion have a tubular seal portion respectively. The extruded portion includes a thin wall portion at a predetermined area that includes at least one portion of the end of the tubular seal portion. The thin wall portion is thinner than other portions. The molded portion includes an extended portion that extends toward the thin wall portion and covers the thin wall portion.

According to the above-mentioned invention, the cavity for forming the molded portion is defined by closing the movable mold, and the cavity includes a space for the extended portion that is a counterpart of the thin wall portion. Thus the thin wall portion is not compressed easily by the mold apparatus because of the space corresponding to the extended portion next to the thin wall portion. Therefore, after forming the molded portion and being picked it up, an expansion around the end of the thin wall portion is limited. As a result, a difference in the dimension between the extruded portion and the molded portion is limited at the thin wall portion, which improves the appearance and the seal performance of the weather strip.

### BRIEF DESCRIPTION OF THE DRAWINGS

The accompanying figures, in which like reference numerals refer to identical or functionally similar elements throughout the separate views and which, together with the detailed description below, are incorporated in and form part of the specification, serve to further illustrate various embodiments and to explain various principles and advantages all in accordance with the present invention.

FIGS. 1A and 1B illustrate the relationship between a mold apparatus and an end of an extruded portion. FIG. 1A is a partial cross section view showing that the extruded portion is set in the mold apparatus. FIG. 1B is a partial cross section view showing a molten material injected into a cavity of the mold apparatus;

FIG. 2 is a perspective view showing fixing positions of weather strips on a vehicle;

FIG. 3 is an end view of the extruded portion;

FIG. 4 is a partial cross section view showing the end of the extruded portion before being cut off to form a thin wall portion;

FIG. 5 is a partial cross section view showing the end of the extruded portion after being cut off to form the thin wall portion;

FIG. 6 is a partial cross section view showing another embodiment having a different shape of the thin wall portion and injected with the molten material in their cavity; and

FIGS. 7A and 7B illustrate the relationship between an extruded portion and a molded portion in a conventional weather strip. FIG. 7A is a partial cross section view showing the connecting portion at the mold forming. FIG. 7B is a partial cross section view showing the connecting portion removed from the mold apparatus.

### DETAILED DESCRIPTION OF THE PREFERRED EMBODIMENTS

Referring now to the drawings in which like reference numbers reference like parts, a weather strip will be described.

As shown in FIG. 2, a vehicle 1 (a convertible car) of the present invention has a retractable roof 2. A plurality of weather strips are provided on the peripheral portion of the roof 2.

The roof 2 is folded by left and right divided frames. A plurality of the weather strips are provided on each frame. The weather strips include a front glass sealing weather strip 3, a rear glass sealing weather strip 4, and a rear quarter sealing weather strip 5. The front glass sealing weather strip 3 and the rear glass sealing weather strip 4 mainly seal the upper edge of a door glass G that can be moved up and down. The rear quarter sealing weather strip 5 seals the corresponding frame, the roof 2 and the upper rear edge of the door glass G.

Still referring to FIG. 2, a front weather strip 9 is fixed along a front pillar 7 and a front glass roof portion 8. A pillar portion 10 of the front weather strip 9 corresponding to the front pillar 7 seals the front edge of the door glass G.

The pillar portions 10 of the front glass sealing weather strip 3, the rear glass sealing weather strip 4, the rear quarter glass sealing weather strip 5 and the pillar portion 10 of the front weather strip 9 include a tubular seal portion in order to seal the door glass G. The front glass sealing weather strip 3, the rear glass sealing weather strip 4 and the rear quarter sealing weather strip 5 include an extruded portion and a molded portion. Each molded portion is formed continuously with the end of the associated extruded portion. The molded portions are indicated by dotted areas of FIG. 2. The pillar portion 10 of the front weather strip 9 includes molded portions (dotted area of FIG. 2) at the front end and the corner. And the pillar portion 10 further includes an extruded portion at the rest of the pillar portion 10.

Hereinafter the present embodiment will be described in detail with reference to the front glass sealing weather strip 3.

As above mentioned, the front glass sealing weather strip 3 includes an extruded portion 12, a front molded portion 13, and a rear molded portion 14. The molded portions 13, 14 are continuously formed on both ends of the extruded portion 12, respectively. The extruded portion 12 and the molded portions 13, 14 are preferably made of ethylene-propylene-diene copolymerization rubber (EPDM) which is a rubber-like material. In this embodiment, the molded portions 13, 14 are made of softer material than the extruded portion 12.

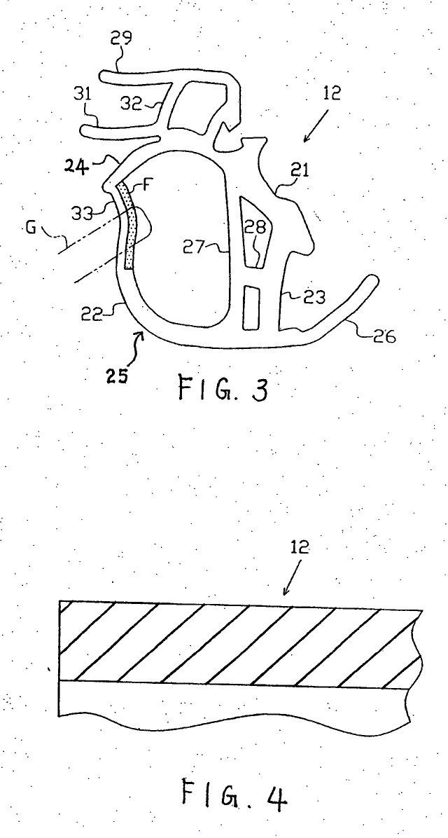

Referring to FIG. 3, the extruded portion 12 is attached to a metal retainer (not shown) fixed on the frame. The extruded portion 12 includes a fixing base 21 for engaging the retainer and a tubular seal portion 22 formed integrally with the fixing base 21. The tubular seal portion 22 includes an inner wall portion 23, an outer wall portion 24 and a main seal portion 25. The main seal portion 25 connects the inner wall portion 23 and the outer wall portion 24 and seals the upper edge of the door glass G. A seal lip 26 extends from the inner wall portion 23. The end of the seal lip 26 contacts the frame. A first bridge portion 27 is formed integrally to connect the tubular seal portion 22 and the fixing base 21. A second bridge portion 28 is formed integrally to connect the first bridge portion 27 and the inner wall portion 23. On the other side, two lips 29, 31 are formed on an outer wall portion 24, and a lip bridge portion 32 is formed integrally with the lips 29, 31.

The front molded portion 13 and the rear molded portion 14 have almost the same cross sectional shape as the extruded portion 12. In the present embodiment, the thickness of the seal portions of the extruded portion 12, such as the tubular seal portion 22, is less than that of the front and rear molded portions 13, 14. Therefore, the load caused by the material hardness for sealing the door glass G is approximately same for the molded portion 13, 14 and the extruded portion 12.

A description of the method of manufacturing the front glass sealing weather strip 3 follows. An elongated extrusion product is primarily formed by an extruder (not shown). Thus, the fixing base 21 and the tubular sealing portion 22 of the extruded portion 12 are formed by the extruder. The extruded portion 12 of the front glass sealing weather strip 3 is formed by cutting the elongated extrusion product to a predetermined length. As shown in FIG. 4, the elongated extrusion product is cut along a plane that is perpendicular to the longitudinal axis of the extrusion.

In FIG. 3, at the end of the extruded portion 12, a predetermined area F (dotted area of FIG. 3) of the tubular sealing portion 22 is cut obliquely by a cutting apparatus (not shown). The predetermined area F is a side wall portion of the tubular sealing portion 22 that contacts the door glass G. Thus, as shown in FIG. 5, a removal portion 36 (dotted triangular area) of the wall is removed. More specifically, a thin wall portion 37 having a thickness A and a taper at an angle of X degrees is formed at the end of the extruded portion 12. In the illustrated embodiment, the thickness A is one-half of the thickness B, but the thickness A is preferably from one-half to one third of the thickness B. The angle X is 45 degrees in the illustrated embodiment, but is preferably from 30 to 70 degrees.

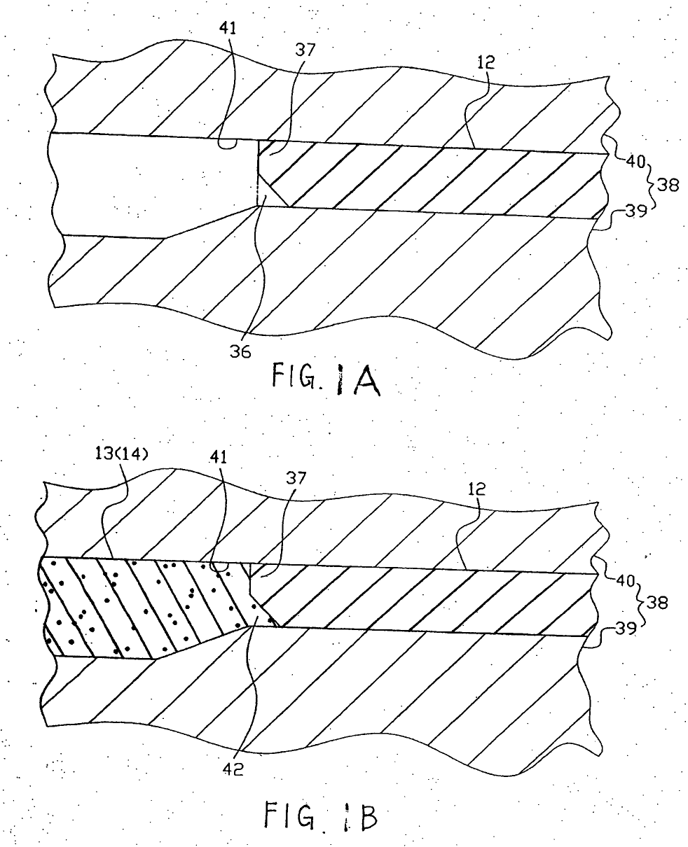

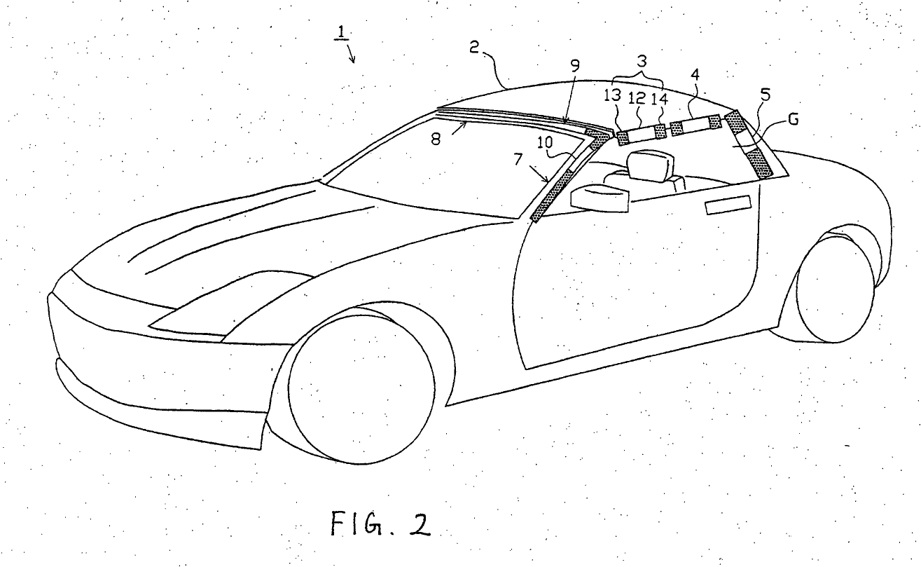

As shown in FIG. 1A, the end of the seal portion 22 of the extruded portion 12 is placed at a predetermined position on a core 39 of a mold apparatus 38. The core 39 with the extruded portion 12 and a movable mold 40 are fixed in the mold apparatus 38. Thus, the extruded portion 12 is fixed in the mold apparatus 38 and a cavity 41 is defined in the mold apparatus 38. When the mold apparatus 38 is closed, the end of the extruded portion 12 is compressed to reduce its thickness by ten percent as a result of clamping the mold apparatus 38. However, the thin wall portion 37 is not compressed by the mold apparatus 38 because the thin wall portion 37 is not clamped from opposite sides like the remainder of the extruded portion 12. In other words, the cavity includes the inside part of the thin wall portion 37 (the removal portion 36), so the thin wall portion 37 cannot be compressed by the mold apparatus 38.

As shown in FIG. 1B, unvalcanized EPDM is injected into the cavity 41 from a gate (not shown) in order to form the molded portions 13, 14. EPDM is also injected into the space corresponding to the removal portion 36. More specially, the molded portions 13, 14 are formed integrally with the extruded portion 12 and provide an extended portion 42, which extends toward the extruded portion 12. During the molding process, the thin wall portion 37 is compressed outwardly of the tubular sealing portion 22 by the pressure of the injected EPDM in order to form the extended portion 42. Therefore, the EPDM is prevented from flowing to the outside of the thin wall portion 37. As a result, a mold flash is merely formed at the outside of the joints between the molded portions 13, 14 and the extruded portion 12. As a result, the appearance of the finished product (weather strip) is improved.

After the injection molding process and the vulcanization, the molded portions 13, 14 are formed integrally with the extruded portion 12 by vulcanized EPDM. Then, the front glass sealing weather strip 3 is taken out from the mold apparatus 38. Then the end of the extruded portion 12 that was inserted into the mold apparatus 38 tends to expand to its original thickness. Because the molded portions 13, 14 do not expand, there might be a difference in dimension between the extruded portion 12 and the molded portion 13, 14 if not for the thin wall portion 37. Because the thin wall portion 37 was not significantly compressed during the molding process, there is no significant difference in dimension between the extruded portion 12 and the molded portion 13, 14 at the thin wall portion 37. As a result, the appearance of the resulting product is improved. Defects in the sealing performance due to the difference in dimension are also prevented.

In addition, the thin wall portion 37 is only formed at the one part (the predetermined area) of the edge of the tubular sealing portion 22. The remainder, other than the thin wall portion 37, of the extruded portion 12 that is inserted into the mold apparatus 34 is positively retained and stabilized by the mold apparatus 38. Therefore, the molding is performed stably in the mold apparatus 38.

The thin wall portion 37 is thick enough to keep its shape because, in the embodiment of FIG. 1A, the thickness of even the thinnest portion is one-half of the thickness B. Therefore, the molding process is more stable. As a result, mold flash scarcely occurs at the outside of the connecting portion between the molded portion 13, 14 and the extruded portion 12. Therefore, the appearance of the resulting product is improved.

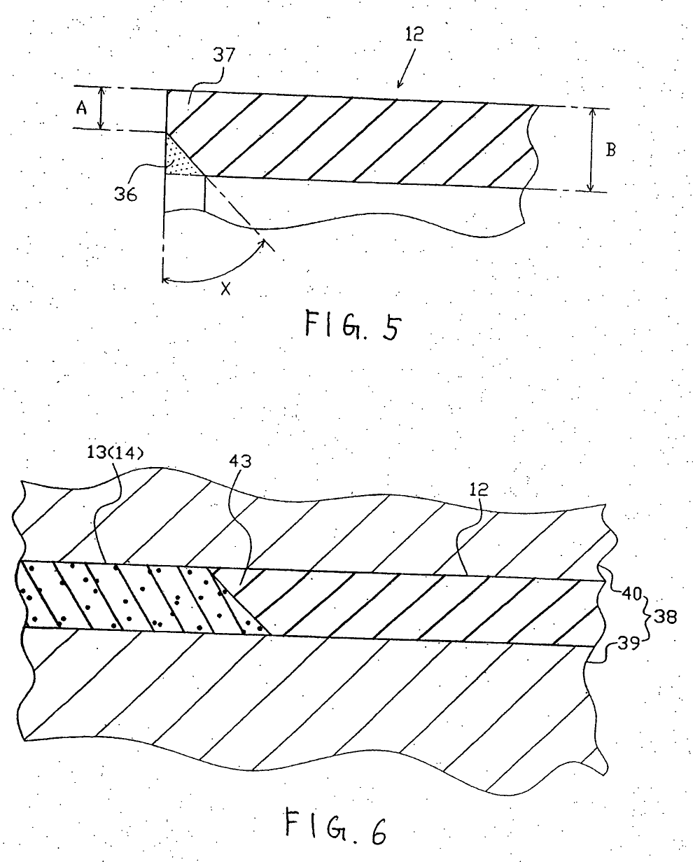

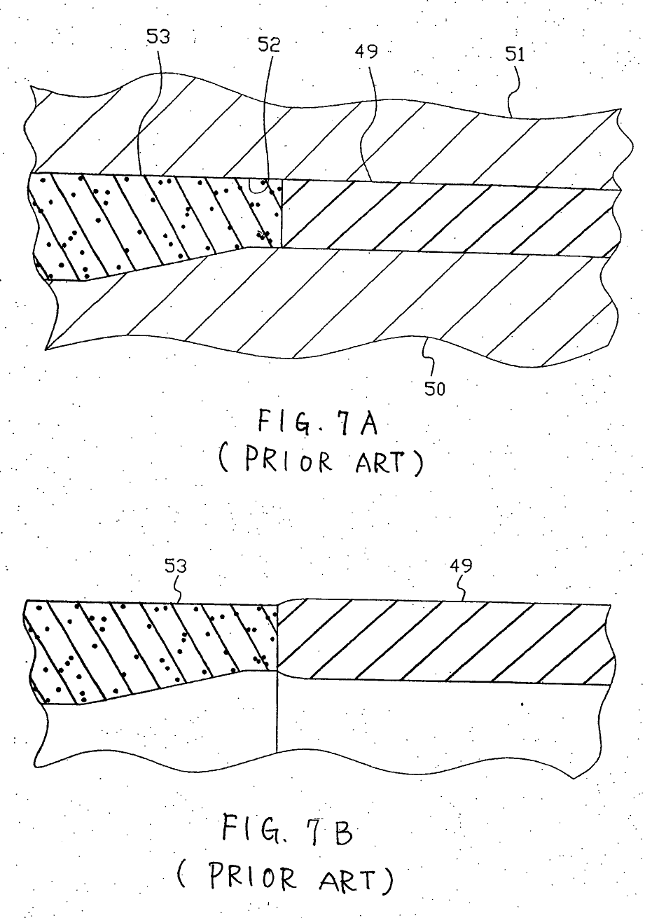

The thin wall portion 37 need not always have the thickness A. As shown in FIG. 6, a sharp thin wall portion 43 can be formed. The thickness of the molded portion 13, 14 and the extruded portion 12 can be same. The thin wall portion 37 can be applied to other portions of the edge of the tubular seal portion 22 as well. The degree of hardness of the material used for the molded portion 13, 14 and the extruded portion 12 can be same. The rubber-like material is not limited to EPDM; other rubber materials, thermoplastic resin, or thermoplastic elastomer can be used for the molded portion 13, 14 and the extruded portion 12. The weather strip of the present invention is not limited to use on convertible automobiles. It can be applied to other types of weather strips, such as a roof weather strips for hard top automobiles and door weather strips. In particular, the present invention is the most effective in a weather strip having a thin wall portion at a tubular seal portion.

The disclosure is intended to explain how to fashion and use various embodiments in accordance with the invention rather than to limit the true, intended and fair scope and spirit thereof. The foregoing description is not intended to be exhaustive or to limit the invention to the precise form disclosed. Modifications or variations are possible in light of the above teachings. The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application, and all equivalents thereof, when interpreted in accordance with the breadth to which they are fairly, legally, and equitably entitled.

1. A method of manufacturing a weather strip, comprising:
extruding a rubber-like material to form an extruded portion with a tubular seal portion;
removing at least one part of an end of a wall of the tubular seal portion of the extruded portion to form a thin wall portion;
inserting a core, which is one part of a mold apparatus, into an end of the tubular seal portion;
setting the end of the extruded portion and the core in the mold apparatus;
closing a movable mold part of the mold apparatus to define a cavity, wherein a part of the cavity corresponds to the removed part of the extruded portion in the mold apparatus;
injecting a rubber-like material into the cavity to form a molded portion formed integrally with the extruded portion.

2. A method of manufacturing a weather strip, comprising:
extruding a rubber-like material to form an extruded portion with a tubular seal portion;
removing at least one part of an end of the tubular seal portion of the extruded portion to form a thin wall portion;
opening a movable mold of a mold apparatus;
inserting a mold core, which is one part of the mold apparatus, into an end of the tubular seal portion;
setting the end of the extruded portion and the core in the mold apparatus;
closing the movable mold to define a cavity such that the movable mold and the core do not compress the thin wall portion;
injecting a rubber-like material into the cavity;
solidifying the rubber-like material in the cavity to form a molded portion, which is formed integrally with the extruded portion.

3. A method of manufacturing a weather strip according to claim 1, wherein the removal of the part of the end of the tubular seal portion is performed on an inner surface of the tubular seal portion.

4. A method of manufacturing a weather strip according to claim 1, wherein the removal is performed such that the thickness of the thin wall portion is from one half to one third of the original thickness of the tubular seal portion.

5. A method of manufacturing a weather strip according to claim 1, wherein the thin wall portion is tapered at an angle of thirty to seventy degrees.

6. A method of manufacturing a weather strip according to claim 1, wherein the degree of the hardness of the material used to form the molded portion is less than that of the extruded portion.

7. A method of manufacturing a weather strip according to claim 1, further comprising:
vulcanizing the extruded portion;
vulcanizing the molded portion.

8. A method of manufacturing a weather strip according to claim 1, wherein employing thermoplastic elastomer as the rubber-like material used in the extruding and the injecting.

9. A method of manufacturing a weather strip according to claim 1, further comprising:
vulcanizing the extruded portion;
employing thermoplastic elastomer as the rubber-like material used in the injecting.

10. A method of manufacturing a weather strip according to claim 2, wherein the removal is performed such that the thickness of the thin wall portion is from one half to one third of the original thickness of the tubular seal portion.

11. A method of manufacturing a weather strip according to claim 2, wherein the thin wall portion is tapered at an angle of thirty to seventy degrees.

12. A method of manufacturing a weather strip according to claim 2, wherein the degree of the hardness of the material used to form the molded portion is less than that of the extruded portion.

13. A weather strip used for sealing a door of a vehicle, comprising:
an extruded portion, which includes a tubular seal portion, and a wall of the tubular seal portion includes a thin wall portion at an end of the tubular seal portion; and
a molded portion integrally formed with the extruded portion, wherein the molded portion includes a tubular seal portion, which includes an extended portion that extends toward the extruded portion and covers the thin wall portion.

14. A weather strip according to claim 13, wherein the extended portion is formed on an inside of the tubular seal portion.

15. A weather strip according to claim 13, wherein the thickness of the tubular seal portion of the extruded portion is less than a corresponding tubular seal portion of the molded portion.
